(19) United States
(12) Patent Application Publication
(10) Pub. No.: US 2010/0157038 A1
(43) Pub. Date: Jun. 24, 2010

(54) ENDOSCOPE SYSTEM WITH SCANNING FUNCTION

(75) Inventor: Yoichi HITOKATA, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/644,212

(22) Filed: Dec. 22, 2009

(30) Foreign Application Priority Data
Dec. 22, 2008 (JP) 2008-326421

(51) Int. Cl. H04N 7/18

(52) U.S. Cl. 348/68; 348/E07.085

(57) ABSTRACT

An endoscope system has an optical fiber that is configured to transmit illumination light emitted from a light source to the tip portion of a scope; a scanner that is configured to spirally scan a target area with the illumination light by vibrating the tip portion of said optical fiber; and a pixel signal detector that is configured to detect pixel signals on the basis of light reflected from the target area at a given sampling rate. The endoscope system further has an image-pixel generator that generates image pixels of an observation image on the basis of the pixel signals sampled or detected in accordance to the sampling rate. The image-pixel generator generates each image pixel from a “proximity pixel group”.

### BACKGROUND OF THE INVENTION

1. Field of the Invention

The present invention relates to an endoscope system that scans illumination light over a target area, such as tissue. In particular, it relates to generating an observation image.

2. Description of the Related Art

An endoscope system with scanning functionality is equipped with a scanning fiber, such as a single mode type of fiber, which is provided in an endoscope. As described in U.S. Pat. No. 6,294,775 and U.S. Pat. No. 7,159,782, the tip portion of the scanning fiber is held by an actuator, such as a piezoelectric device, that vibrates the tip portion spirally by modulating and amplifying the amplitude (waveform) of the vibration. Consequently, illumination light, passing through the scanning fiber, is spirally scanned over an observation area.

Light reflected off the observation area enters into an image fiber and is transmitted to a processor via the image fiber. The transmitted light is transformed to pixel signals by photosensors. Then, each one of the pixel signals detected in time-sequence is associated with a scanning position. Thus, a pixel signal in each pixel is identified and image signals are generated. The spiral scanning is periodically carried out on the basis of a predetermined time-interval (frame rate), and one frame's worth of pixel signals are successively read from the photosensors in accordance with the frame rate.

Though pixel signals are detected by a photosensor at a predetermined sampling rate, full pixel signals are not raster-arrayed. Only a portion of the detected pixel signals are utilized to form an observation image; the remaining pixel signals are abandoned. The selection of pixel signals for creating the observation image is carried out, for example, using so-called down sampling. Many pixel signals are not used in the central portion of a spiral scan because the length of one revolution is relatively short in the central portion. Also, when selecting or picking up pixel signals at a constant pixel interval, a selected pixel signal may have a large amount of noise, whereas a neighboring pixel signal may not include any noise. In this case, it is difficult to generate a high quality image.

### SUMMARY OF THE INVENTION

An object of the present invention is to provide an endoscope system that is capable of obtaining a high quality image by effectively utilizing detected pixel signals.

An endoscope system according to the present invention has an optical fiber that is configured to transmit illumination light emitted from a light source to the tip portion of a scope; a scanner that is configured to spirally scan a target area with the illumination light by vibrating the tip portion of said optical fiber; and a pixel signal detector that is configured to detect pixel signals on the basis of light reflected from the target area at a given sampling rate. The endoscope system further has an image-pixel generator that generates image pixels of an observation image on the basis of the pixel signals sampled or detected in accordance to the sampling rate.

In the present invention, the image-pixel generator generates each image pixel from a “proximity pixel group”. The proximity pixel group represents a group of pixel signals that are created from a subject pixel signal and the surrounding pixel signals. The subject pixel signal is located on a pixel-position of a corresponding image pixel. The surrounding pixel signals may be created from pixel signals that are arrayed on a present scanning line, or two-dimensionally over a plurality of spiral scan lines. Also, the proximity pixel group may be composed of pixel signals detected in one single frame interval or over two frame intervals.

Each image pixel is generated while utilizing the subject pixel signal and the surrounding pixel signals that are tightly associated with the image pixel. Thus, a high quality observation image is realized instead of an image generated from pixels with a large amount of noise.

For example, the image-pixel generator may carry out at least one of an average value calculating process, a low-pass filtering process, a center pixel sampling process, and a maximum value calculating process.

Considering that it is preferable to generate image pixels by using real-time pixel information, the image-pixel generator may configure the proximity pixel group on the basis of pixel signals located along a spiral scan line both before and after the subject pixel signal. Namely, the image-pixel generator may define the surrounding pixel signals by the fore-and-aft pixel signals arrayed on the same scan line.

On the other hand, when utilizing the surrounding pixel signals as much as possible, the image-pixel generator may configure the proximity pixel group on the basis of pixel signals that are arrayed two-dimensionally over a plurality of spiral scan lines. Especially, to select or define a balanced group of pixel signals that are adjacent to the subject pixel signal, the image-pixel generator may configure the proximity pixel group on the basis of pixel signals detected in a previous frame interval. For example, the proximity pixel group may be created from a block composed of “3×3” pixels that are arrayed on three spiral scan lines adjacent to one another. Furthermore, it is possible to utilize both the real-time pixel information and the previously detected pixel information.

When the sampling rate is constant, a pixel interval between detected pixel signals varies with each spiral scan line. The larger the radius of a spiral scan line, the longer the pixel interval becomes. Especially, in the exterior portion of the observation image, a pixel interval is close to an interval between the neighboring image pixels. Therefore, if the surrounding pixel signals are used to generate image pixels, the value of an image pixel may become uniform in the exterior portion.

To prevent this situation, the image-pixel generator may use the proximity pixel group to generate image pixels while scanning a predetermined area. The area is defined such that a ratio of the number of image pixels to the number of sampled (detected) pixel signals exceeds a given threshold value. For example, the image-pixel generator generates image pixels by using the proximity pixel group while scanning a central area. On the other hand, when scanning an area other than the predetermined area, the image-pixel generator may apply a down-sampling process to the pixel signals. The down-sampling process is based on a given pixel interval that is defined in each spiral scan line.

When the luminance level of the observation image is high, it is preferable to carry out a signal process that eliminates noise, such as a low-pass filter process. Also, when many noisy pixel signals are included in the pixel signal total, it is preferable to change the number of pixel signals constituting the proximity pixel group. Therefore, the image generator may change at least one of either the number of pixel signals constituting the proximity pixel group or an image-pixel generating method in accordance to the luminance level of one frame's worth of pixel signals.

An apparatus for image-pixels of an observation image according to an endoscope system, according to another aspect of the present invention, has a pixel signal detector configured to detect pixel signals on the basis of light reflected from a target area at a given sampling rate while spirally scanning the target area with illumination light in accordance to a given frame interval; and an image-pixel generator that generates image-pixels of an observation image on the basis of the detected pixel signals. The image-pixel generator generates each image pixel from a proximity pixel group that comprises a subject pixel signal located at a position of the image pixel and the surrounding pixel signals.

A method for image-pixels of an observation image according to an endoscope system, according to another aspect of the present invention, includes: a.) detecting pixel signals on the basis of light reflected from a target area at a given sampling rate while spirally scanning the target area with illumination light in accordance to a given frame interval; and b.) generating image-pixels of an observation image on the basis of the detected pixel signals. The generating includes generating each image pixel from a proximity pixel group that comprises a subject pixel signal located at a position of the image pixel and the surrounding pixel signals.

### BRIEF DESCRIPTION OF THE DRAWINGS

The present invention will be better understood from the description of the preferred embodiments of the invention set forth below, together with the accompanying drawings, in which:

FIG. 1 is a block diagram of an endoscope system according to a first embodiment;

FIG. 2 is an illustration of the scanning optical fiber, scanning unit, and spiral scan pattern;

FIG. 3 is a schematic block diagram of the signal processing circuit;

FIGS. 4A and 4B show the process of generating image pixels of an observation image;

FIG. 5 is a schematic view of a spiral scan;

FIG. 6 is a flowchart of an image-pixel generating process;

FIG. 7 is a block diagram of a signal processing circuit according to the second embodiment;

FIG. 8 is a block diagram of the pixel-information generating circuit;

FIG. 9 is a view of a pixel block in a previous frame interval;

FIGS. 10A and 10B are views of a pixel-generating method according to the second embodiment;

FIG. 11 is a timing chart of an image-pixel generating process and recording process; and

FIG. 12 is a timing chart of an image-pixel generating process according to the third embodiment.

### DESCRIPTION OF THE PREFERRED EMBODIMENTS

Hereinafter, the preferred embodiments of the present invention are described with reference to the attached drawings.

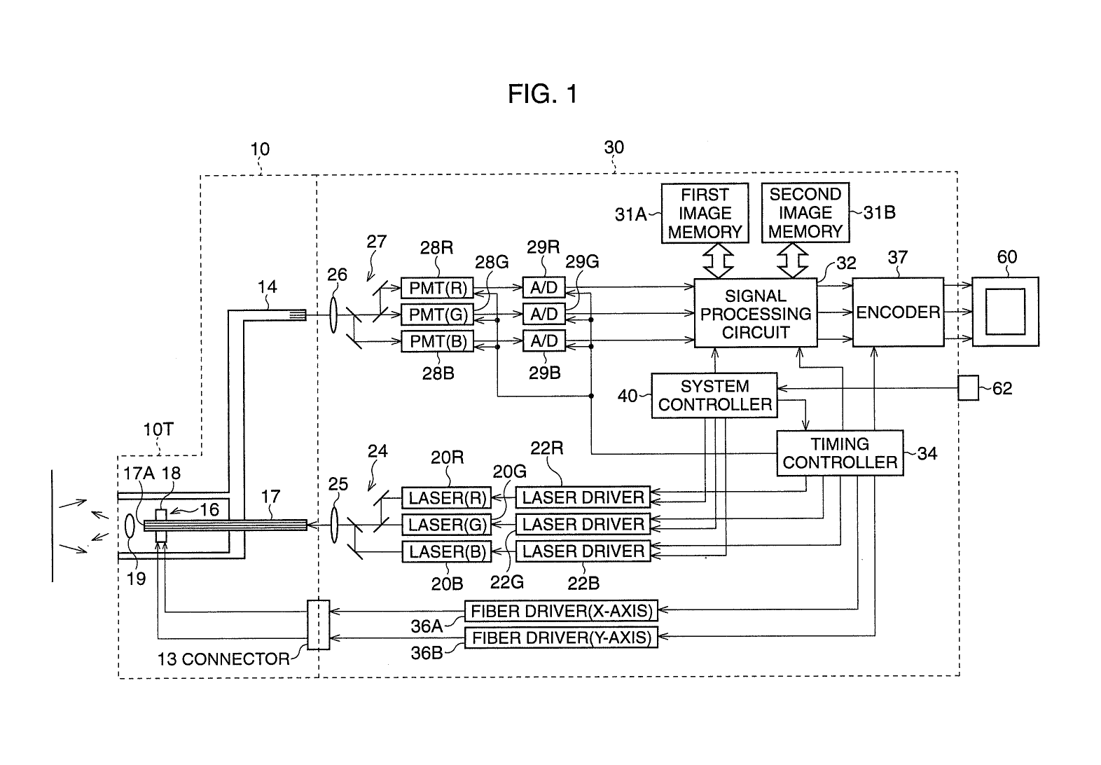

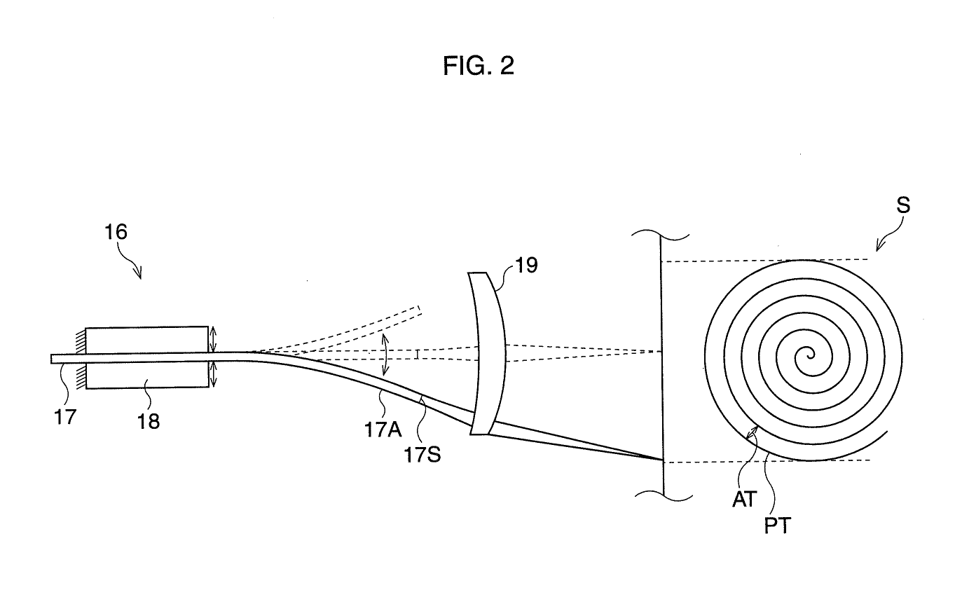

FIG. 1 is a block diagram of an endoscope system according to a first embodiment. FIG. 2 is an illustration of the scanning optical fiber, scanning unit, and spiral scan pattern.

The endoscope system is equipped with a processor 30 and an endoscope 10 that includes a scanning fiber 17 and an image fiber 14. The single mode type of scanning fiber 17 transmits illumination light, whereas the image fiber 14 transmits light that is reflected off an observation target S such as tissue. The endoscope 10 is detachably connected to the processor 30, and the monitor 60 is connected to the processor 30.

The processor 30 has three lasers 20R, 20G, and 20B, which emit red, green, and bluelight, respectively. The lasers 20R, 20G, and 20B are driven by three laser drivers 22R, 22G, and 22B, respectively. The simultaneously emitted red, green, and blue light is collected by half-mirror sets 24 and a collection lens 25. Consequently, white light enters into the scanning fiber 17 and travels to the tip portion 10T of the endoscope 10. The light exiting from the scanning fiber 17 illuminates the target S.

As shown in FIG. 2, a scanning unit 16 is provided in the scope tip portion 10T. The scanning unit 16 has a cylindrical actuator 18 and scans illumination light over the target S. The optical fiber 17 passes through the axis of the actuator 18. The fiber tip portion 17A, which cantilevers from the actuator 18, is supported or held by the actuator 18.

The actuator 18 fixed at the scope tip portion 10T is, herein, a piezoelectric tubular actuator that resonates the fiber tip portion 17A in two dimensions. Concretely speaking, the actuator 18 vibrates the fiber tip portion 17A with respect to two axes that are perpendicular to one another, in accordance with a resonant mode. The vibration of the fiber tip portion 17A spirally displaces the position of the fiber end surface 17S from the axial direction of the optical fiber 17.

The light emitted from the end surface 17S of the scanning fiber 17 passes through an objective lens 19, and reaches the target S. A course traced by a scanning beam, i.e., a scan line PT, forms a spiral pattern (see FIG. 2). Since a spiral interval AT in a radial direction is tight, the total observation area S is illuminated by spirally scanned light.

Light reflected from the target S enters the image fiber 14 and is transmitted to the processor 30. When the reflected light exits from the image fiber 14, it is divided into R, G, and B light by an optical lens 26 and half-mirror sets 27. The separated R, G, and B light then continues on to photosensors 28R, 28G, 28B, respectively, which transform the R, G, and B light to image-pixel signals corresponding to colors “R”, “G”, and “B”.

The generated analog image-pixel signals are converted to digital image-pixel signals by A/D converters 29R, 29G, and 29B and then fed into a signal processing circuit 32, in which a mapping process is carried out. The successively generated digital R, G, and B image-pixel signals are arrayed in accordance to the order of a spiral scanning pattern. In the mapping process, each of the digital R, G, and B image-pixel signals are associated with a corresponding scanning position, so that raster-arrayed image-pixel signals are formed. Consequently, the pixel position of each of the R, G, and B digital image-pixel signals is identified, in order, and one frame's worth of digital R, G, and B image-pixel signals are generated successively.

In the signal processing circuit 32, the generated two-dimensional image-pixel signals are subjected to various image-processing procedures, including a white balance process, so that video signals are generated. The generated video signals are sent to the monitor 60 via an encoder 37, thus an observation image is displayed on the monitor 60.

A system controller 40, which includes a ROM unit, a RAM unit, and a CPU, controls the action of the video processor 30 and the videoscope 10 by outputting control signals to the signal processing circuit 32, the laser driver 22R, 22G, and 22B, etc. A control program is stored in the ROM unit. A timing controller 34 outputs synchronizing signals to fiber drivers 36A, 36B for driving the scanning unit 16 and the laser drivers 22R, 22G, and 22B to synchronize the vibration of the fiber tip portion 17A with the timing of the emission of light. A mode button 62 is operated to change or enhance the resolution of an observation image. When the mode button 62 is operated, a normal observation mode is switched to a pixel generation mode, and an image-pixel generating process that uses a plurality of sampled pixel signals is carried out, as described below.

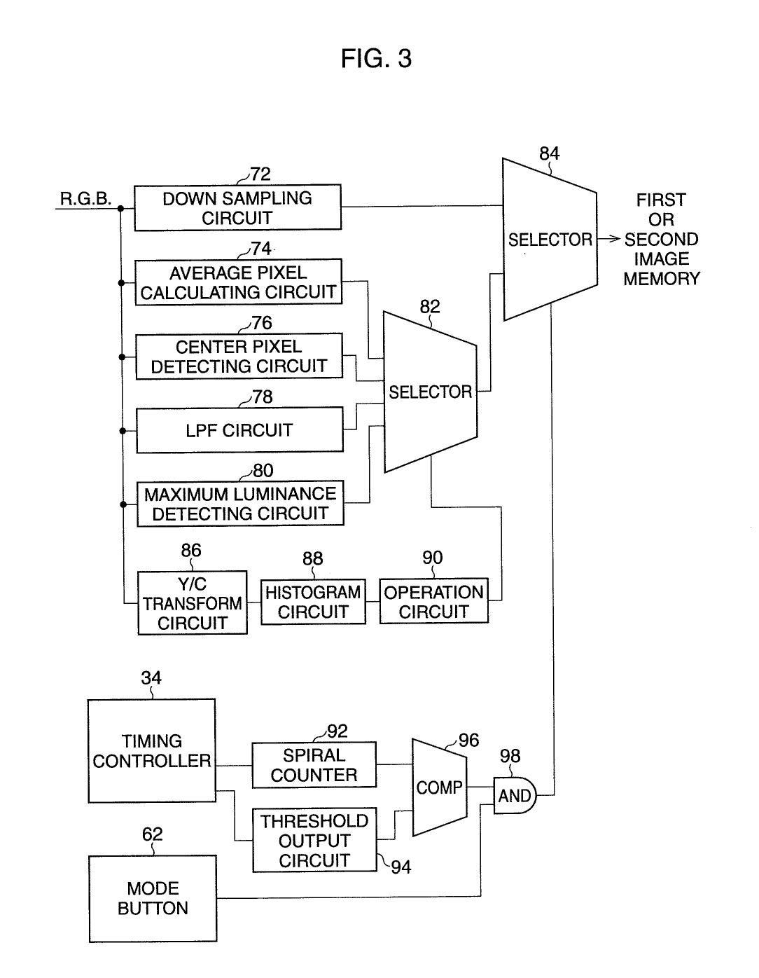

FIG. 3 is a schematic block diagram of the signal processing circuit 32.

The signal processing circuit 32 has a down-sampling circuit 72, an average pixel calculating circuit 74, a center pixel detecting circuit 76, a low-pass filter (LPF) circuit 78, and a maximum luminance detecting circuit 80. Each circuit is selectively connected to a selector 82. Also, the down-sampling circuit 72 and the selector 82 are connected to a selector 84. Digital pixel signals that are detected in accordance to a predetermined sampling rate (a given frequency of clock pulses) are input as pixel data to the down-sampling circuit 72, the average luminance calculating circuit 74, the center-pixel detecting circuit 76, the low-pass filter (LPF) circuit 78, and the maximum luminance detecting circuit 80.

The down-sampling circuit 72, which is constructed of a delay circuit, carries out a down-sampling process. Namely, the down-sampling circuit 72 samples or selects specific pixels from a sequence of detected pixel signals in accordance to predetermined pixel intervals that are defined for each spiral line. Each pixel signal selected is hereinafter called a “subject pixel”. The subject pixels are substantially located at pixel positions of image pixels that constitute an observation image.

The average pixel detecting circuit 74 calculates a series of average pixels from the subject pixels and the surrounding pixel signals. For example, a pixel having an average value is calculated from a subject pixel and adjacent fore-and-aft pixel signals. Hereinafter, a series of pixel signals used for generating image pixels is designated as a “proximity-pixel group”.

The center data-detecting circuit 76 detects a pixel having medium luminance level of each proximity pixel group, whereas the LPF circuit 78 samples pixels having low frequency components. The maximum luminance-detecting circuit 80 detects the pixel with maximum luminance from each proximity pixel group.

The signal processing circuit 32 is further equipped with a Y/C transform circuit 86, a histogram circuit 88, and an operation circuit 90. The Y/C transform circuit 86 generates luminance signals from one frame's worth of detected pixel signals. Then, the histogram circuit 86 generates histogram data of the luminance signals. The operation circuit 90 calculates a brightness level of an observation image from the histogram data. Herein, an average luminance is calculated.

The selector 82 outputs image-pixel signals to the selector 84 from one of the average pixel calculating circuit 74, the center pixel detecting circuit 76, the LPF circuit 78, or the maximum luminance detecting circuit 80. Also, the selector 82 switches a connecting state to the selector 84 on the basis of the brightness level output from the operation circuit 90.

Furthermore, the signal processing circuit 32 is equipped with a spiral counter 92, a threshold output circuit 94, a comparator 96, and an AND circuit 98. During a spiral scan, the spiral counter counts the number of spirals in each frame interval. The threshold output circuit 94 outputs a signal representing a threshold value. The comparator 96 compares the number of spirals to the threshold value and changes the signal level when the number of spirals exceeds the threshold value. The AND circuit 98 outputs a control signal to the selector 84 on the basis of both a detection signal received from the mode button 62 and a detecting signal generated by the comparator 96. The selector 84 selectively outputs image-pixel signals from either the down-sampling circuit 72 or the selector 82, to the first image memory 31A or the second image memory 31B.

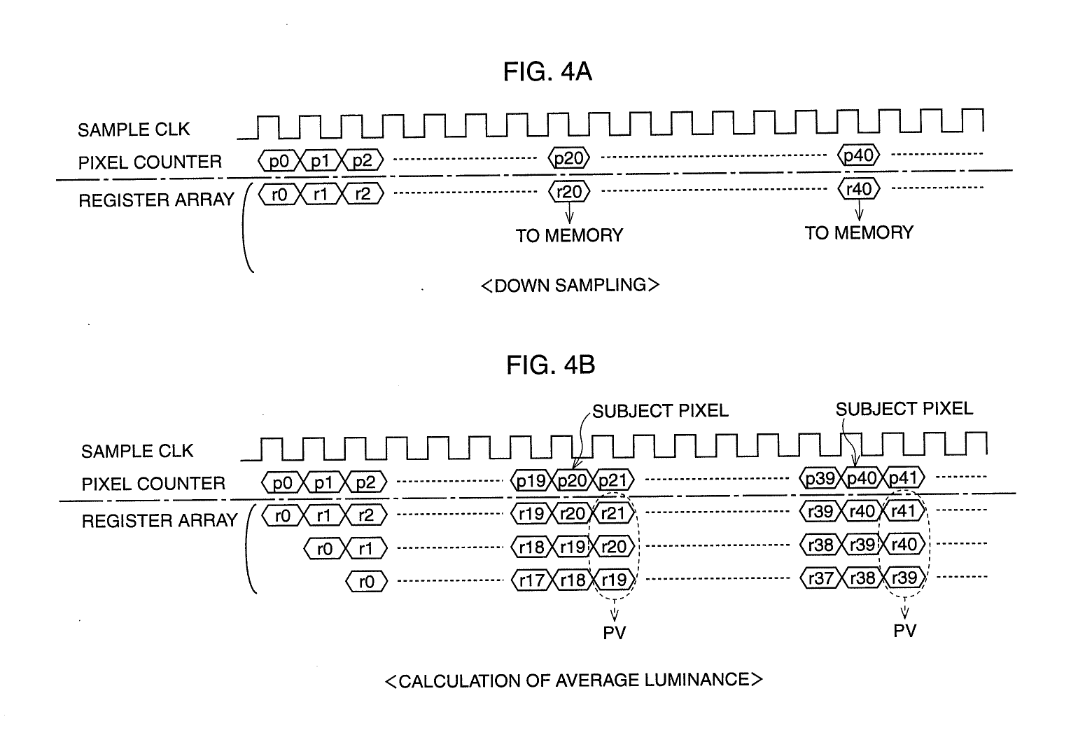

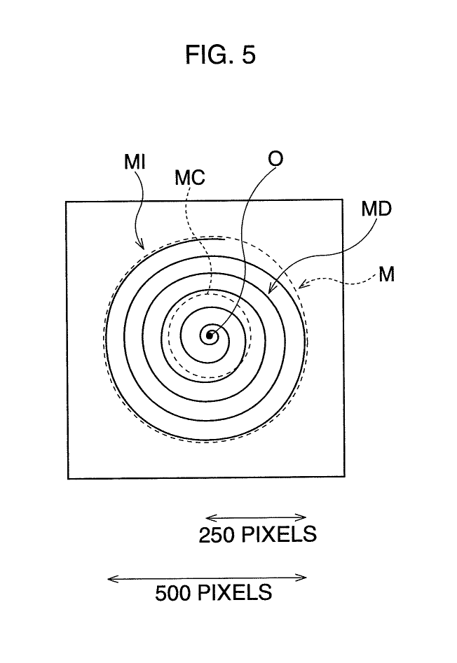

FIGS. 4A and 4B show the process of generating image pixels that constitute an observation image. FIG. 5 is a schematic view of a spiral scan. The generating method is hereinafter explained with reference to FIGS. 4A, 4B, and 5.

As described above, pixel signals are detected in the photosensors 28R, 28G, and 28B in accordance to the predetermined sampling rate. The sampling rate is constant in each spiral scan line, with 2,000 pixel signals per revolution herein detected in time-sequence. On the other hand, an observation image M1 obtained by scanning a scan area M is herein composed of 500×500 image pixels. Therefore, the number of spiral scans carried out in one frame interval is “250”, so that 250 image pixels are arrayed from a scan starting point in a radial direction. Note that an actual density of scan lines in the radial direction is much tighter than shown in FIG. 5.

In the case of the normal observation mode, the “500×500” image pixels are obtained by down sampling via the down-sampling circuit 72. Concretely, pixel signals are sampled or selected from a series of detected pixel signals at a given pixel interval (see FIG. 4A). The pixel interval varies with the number of spirals; the shorter the radius of a spiral scanning line, the shorter the pixel interval becomes.

For example, in a central area MC that includes the center point (scan starting point) O, the length of one revolution is short compared to an exterior area MD of the scan area M. On the other hand, the sampling rate for detecting pixel signals is constant, i.e., 2000 per revolution, for both the central area MC and the exterior area MD. As a result, many pixel signals are abandoned in the central area MC to generate raster-arrayed image pixels, whereas most pixel signals are utilized in the exterior area MD. In the down-sampling circuit 72, a pixel interval for sampling detected pixel signals is adjusted in accordance to the number of counted spirals, i.e., a present scanning line. In FIG. 4A, pixel signals are selected at 20-pixel intervals.

On the other hand, when the image-pixel generation mode is set, image pixels are formed in a manner different from the normal observation mode. Concretely, each image pixel is generated by utilizing a corresponding subject pixel signal and the fore-and-aft pixel signals along the spiral scan line. Each subject pixel signal is decided on by the respective pixel interval of each spiral scan line.

In FIG. 4B, an image-pixel generating process is shown. The average pixel calculating circuit 74 has a shift register that stores detected pixel signals. In the shift register, pixel signals are arrayed two-dimensionally while shifting pixel signals one by one. The average pixel calculating circuit 74 calculates an average pixel from a corresponding subject pixel signal and the fore-and-aft pixel signals. For example, when the subject pixel signal is “P20”, an image pixel PV is generated from the register-arrayed pixel signals. The image pixel PV represents an average of the subject pixel signal “P20” and the fore-and-aft pixel signals “P19” and “P21”.

On the other hand, the LPF circuit 78 selects a pixel signal that has the lowest luminance level of the three pixel signals, i.e., the subject pixel signal and the fore-and-aft pixel signals. Also, the maximum luminance detecting circuit 80 selects a pixel signal that has the maximum luminance level among the three pixel signals. Furthermore, the center pixel detecting circuit 78 selects the pixel signal with the median luminance level among the three pixel signals.

In this way, each image pixel is generated from a plurality of pixel signals that are located on a pixel position of the image pixel and the immediately preceding and following pixel signals. This process is carried out for each of the R, G, and B pixel signals.

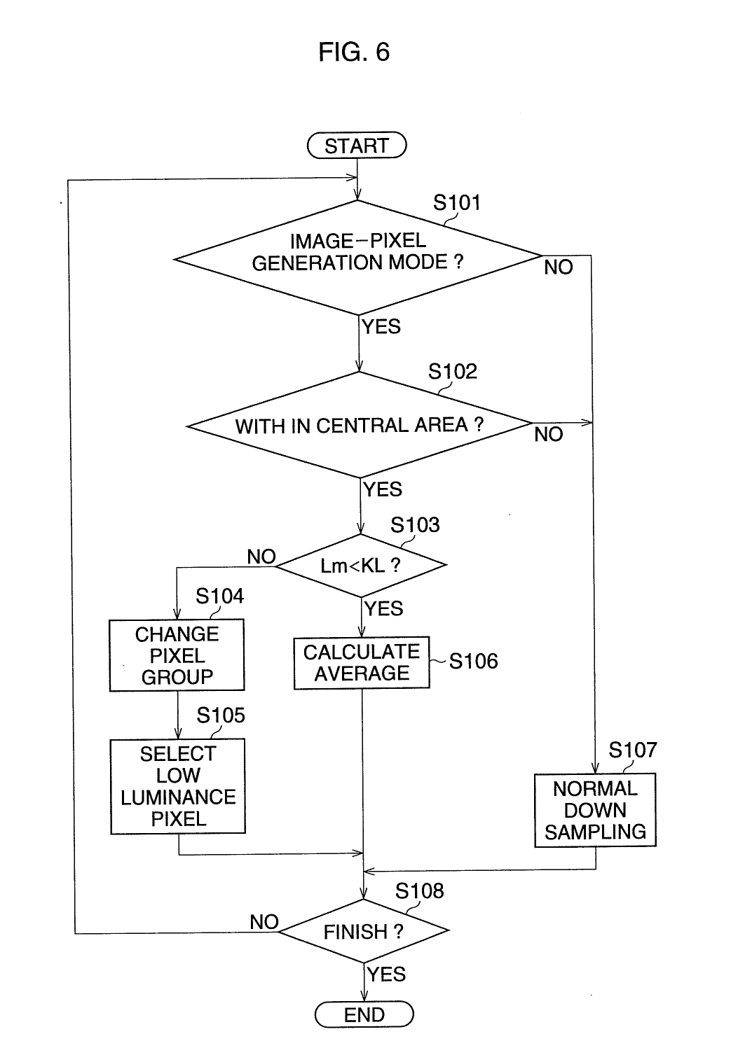

FIG. 6 is a flowchart of an image-pixel generating process.

In Step S101, it is determined whether the mode button 62 has been operated to set the image-pixel generation mode. When the mode button 62 is not operated, the normal down sampling is carried out (S107). Concretely, the selector 84 (see FIG. 2) outputs a selected pixel signal as an image pixel to either the first image memory 31A or the second image memory 31B. On the other hand, when the normal observation mode is switched to the image-pixel generation mode, the process proceeds to Step S102.

In Step S102, it is determined whether the number of the present spiral is equal to or less than a threshold value corresponding to the peripheral line of the central area MC, namely, whether a present scanning position is within the central area MC. When the present scanning position in the central area MC, the process goes to Step S103 to carry out the image-pixel generating process that utilizes adjacent pixel signals. On the other hand, when the present scanning position is outside of the central area MC, the normal down sampling is carried out (S107).

In Step S103, it is determined whether a brightness level Lm obtained by the histogram circuit 88 is less than a given threshold value KL. The threshold value KL is used to determine whether or not pixel signals include an excessive amount of noise. When the brightness level Lm is less than the threshold value KL, an image pixel having an average luminance level is generated by the average pixel calculating circuit 74 (S106). Concretely, the selector 82 (see FIG. 3) outputs a series of average pixel signals to the selector 84, and the selector 84 outputs the average pixel signals to the first image memory 31A or the second image memory 31B.

On the other hand, when the brightness level Lm is equal to or greater than the threshold value KL, the number of pixels defining a proximity pixel group is changed from three to five pixels (S104). Then, image pixels are generated by the LPF circuit 78. Namely, pixel signals that have the lowest luminance levels are output to the first image memory 31A or the second image memory 31B by the selectors 82 and 84 (S105). When the scanning position moves outside of the central area MC, normal down sampling is carried out (S102 and S107). Steps S101 to S107 are repeated until an observation is terminated.

Note that an image-pixel generating process other than the low-pass filtering process may be optionally carried out in accordance to the state of an observation image. For example, when a luminance level of an observation image is extremely low, pixel signals having maximum luminance levels are selected as image pixels. Also, when a captured image is in a moving state in which the resolution is not required, the center pixel detecting circuit 78 may be utilized.

In this way, the endoscope system in the present embodiment is equipped with the scanning fiber 17, and spirally scans a target area with illumination light by vibrating the fiber tip portion two-dimensionally. Then, when the image-pixel generation mode is set, image pixels that constitute an observation image are generated from a series of proximity pixel groups. Each proximity pixel group is composed of a subject pixel signal and fore-and-aft pixel signals, and an average pixel is generated from the three pixel signals.

Thus, the influence of noisy pixels is mitigated and a high quality image is realized. Also, when a luminance level is high, noisy pixels are eliminated by the LPF circuit 78.

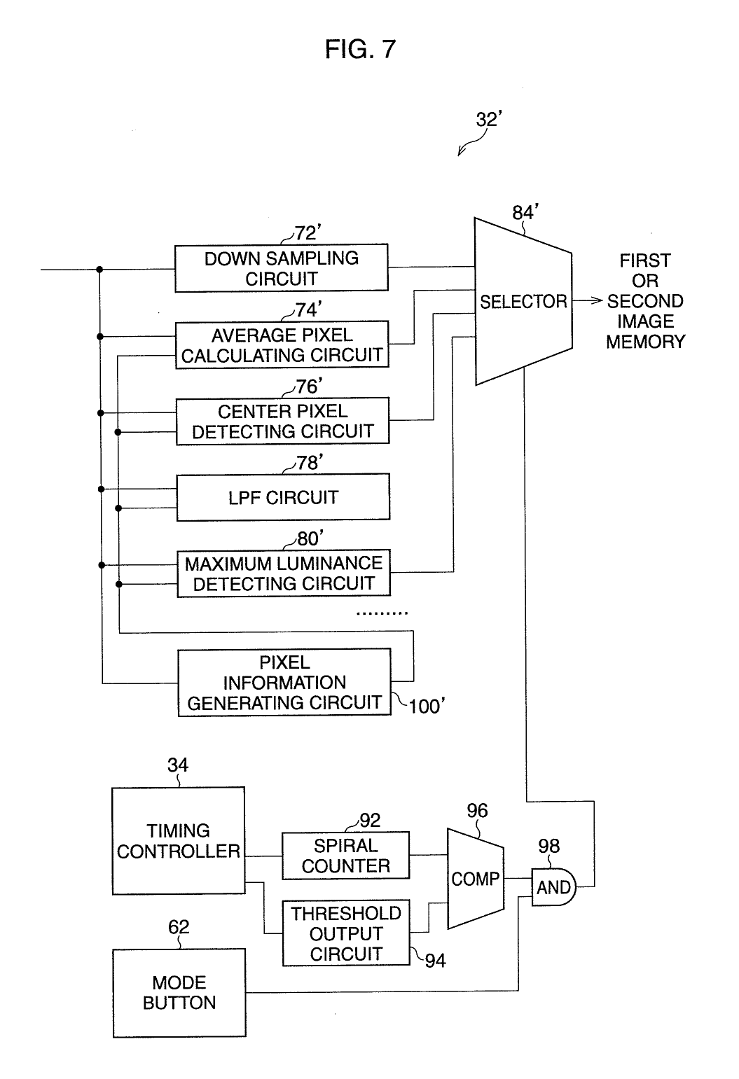

Next, the second embodiment is explained with reference to FIGS. 7 to 11. The second embodiment is different from the first embodiment in that image-pixel signals are generated while utilizing pixel signals detected in a previous frame interval.

FIG. 7 is a block diagram of a signal processing circuit according to the second embodiment.

The signal processing circuit 32′ is equipped with an average pixel calculating circuit 72′, a center pixel detecting circuit 74′, a LPF circuit 78′, and a maximum luminance detecting circuit 80′, each of which is respectively connected to a selector 84′. The signal processing circuit 32′ further has a pixel-information generating circuit 100′. The pixel-information generating circuit 100 receives one frame's worth of pixel signals in succession, and outputs pixel-information to the five circuits in a subsequent frame interval. The selector 84′ outputs pixel signals that are output from one of the five circuits to the first image memory 31A or the second image memory 31B.

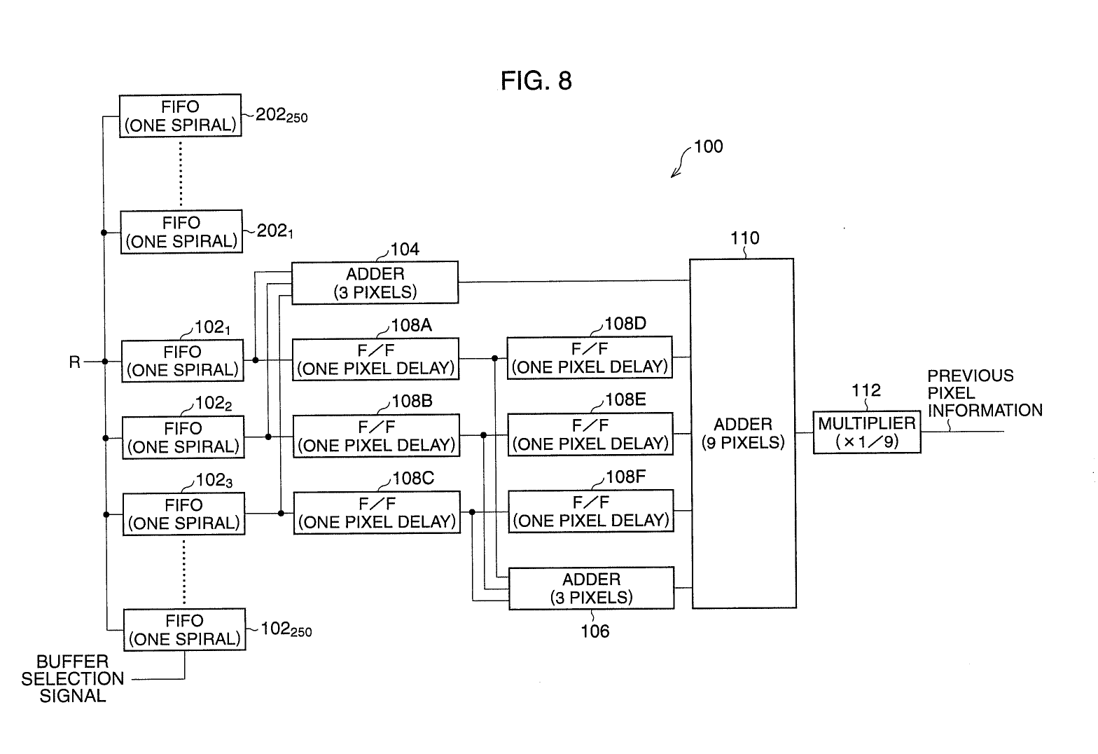

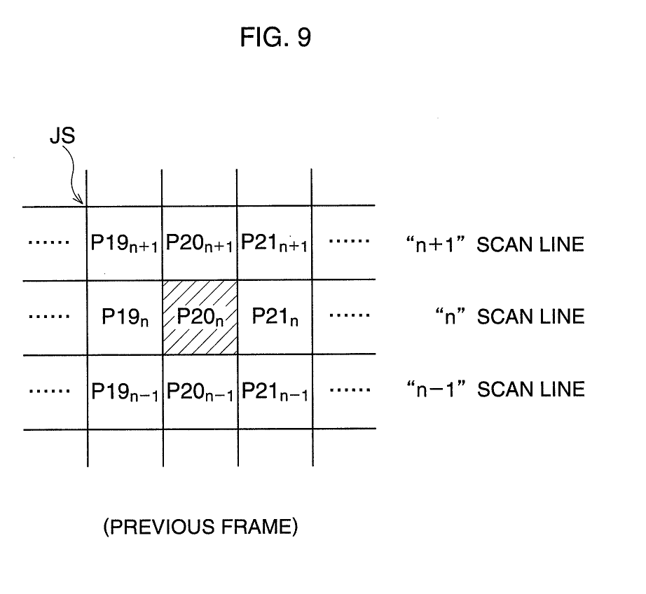

FIG. 8 is a block diagram of the pixel-information generating circuit 100. FIG. 9 is a view of a pixel block in a previous frame interval.

The previous pixel-information generating circuit 100 has buffer memories 102₁ to 102₂₅₀ and buffer memories 202₁ to 202₂₅₀ in accordance to the number of spirals. Pixel signals of each spiral scan line are stored in a corresponding buffer memory. Further, the previous pixel-information generating circuit 100 has three adders (addition devices) 104, 106, and 110; six delay devices 108A to 108F; and a multiplier 112. This circuit system shown in FIG. 8 allows for the calculation of pixel information obtained from a plurality of spiral scan lines in a previous frame interval.

Firstly, nine pixel signals, which are two-dimensionally adjacent to one another and constitute a proximity pixel group composed of 3×3 pixels, are added together. Next, an average pixel of the nine pixels is calculated from previous pixel information data. In FIG. 9, a proximity pixel group JS composed of 9 pixels is shown. The proximity pixel group JS is constructed of a subject pixel P20ₙ and eight pixels: P19ₙ₋₁, P20ₙ₋₁, P21ₙ₋₁, P19ₙ₊₁, P20ₙ₊₁, P21ₙ₊₁; which are all adjacent to one another in an up-down, left-right, or diagonal direction. The subject pixel P20ₙ is detected on the number “n” spiral scan line, whereas the pixels P19ₙ₋₁, P20ₙ₋₁, and P21ₙ₋₁ are detected on the number “n−1” spiral scan line, and the pixels P19ₙ₊₁, P20ₙ₊₁, and P21ₙ₊₁ are detected on the number “n+1” spiral scan line.

A pixel block that is based on a previous frame interval is defined or assigned to each subject pixel signal in a present frame interval. Then, an average pixel is obtained by using previous pixel information.

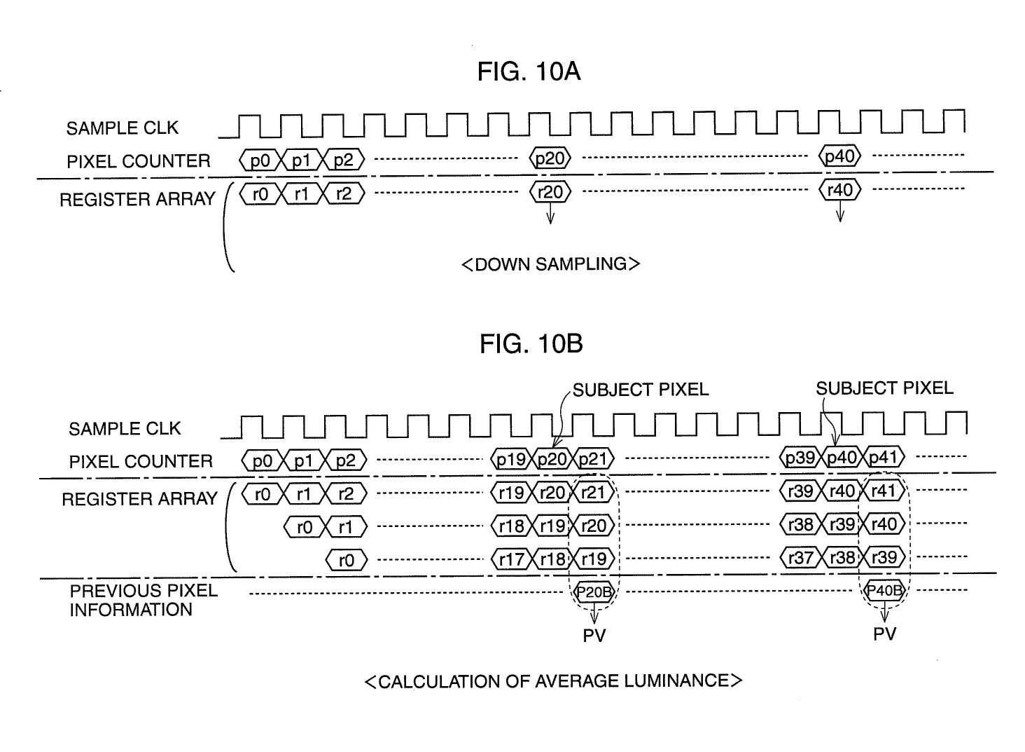

FIGS. 10A and 10B are views of a pixel-generating method according to the second embodiment.

When the image-pixel generation mode is set, image pixels are generated by calculating an average pixel. In the second embodiment, an average value is calculated from the following four pixels: a subject pixel P20, fore-and-aft pixels P19 and P21 (R19 and R21), and the previous average pixel P208. The previous average pixel P20B is obtained from a previous pixel block, as shown in FIG. 9.

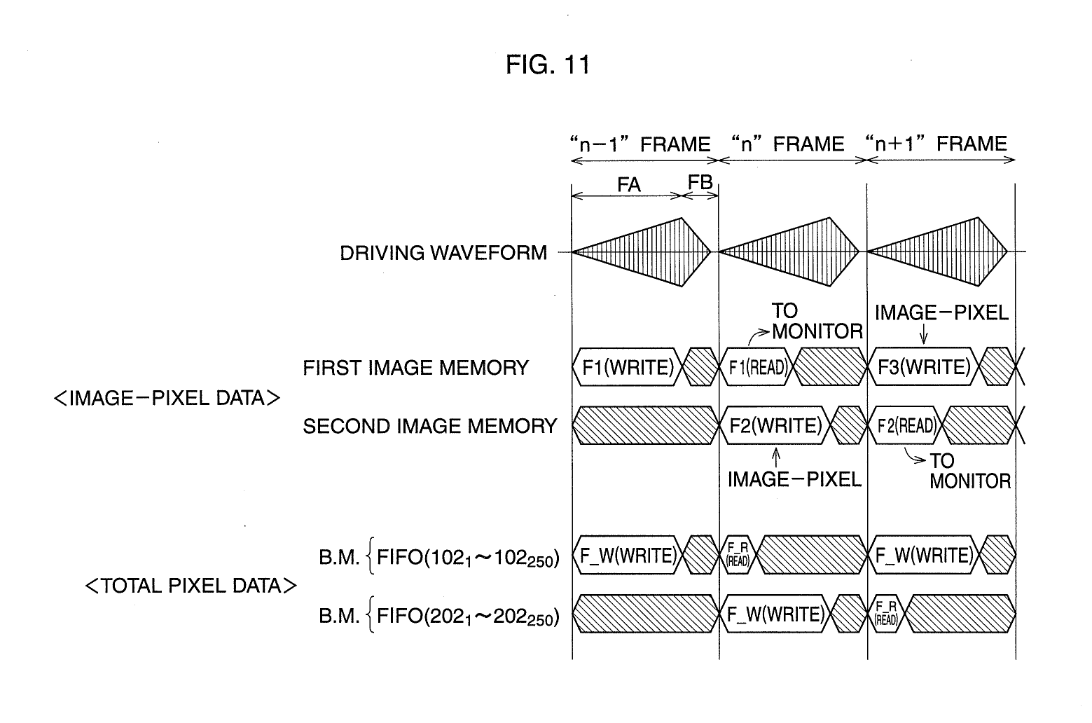

FIG. 11 is a timing chart of an image-pixel generating process and recording process.

During an interval “FA” in the number “n−1” frame interval, one frame's worth of pixel signals are stored in the buffer memories 102₁ to 102₂₅₀. Note that the interval FA represents an actual spiral scan for forming a circular observation image. The remaining interval “FB” represents an interval in which the fiber tip portion 17A returns to the scan starting point.

The stored pixel signals are read from the buffer memories 102₁ to 102₂₅₀ during the number “n” frame interval. At the same time, image pixels are generated from the previous average pixel signal obtained by the previous pixel-information generating circuit 100, and a proximity pixel group detected in the “n” frame interval. The generated image pixels are stored in the second image memory 31B. On the other hand, one frame's worth of pixel signals detected in the number “n” frame interval are stored in the other buffer memories 202₁ to 202₂₅₀. In the number “n+1” frame interval, image pixels are calculated on the basis of the stored pixel signals are stored in the first image memory 31A.

In this way, in the second embodiment, pixel signals that are close to one another, both spatially and temporally, are utilized to generated image pixels. As a result, many pixel signals that are arrayed over a plurality of spiral scan lines and adjacent to one another can be referenced. Note that image pixels may be calculated only from the previous proximity pixel group.

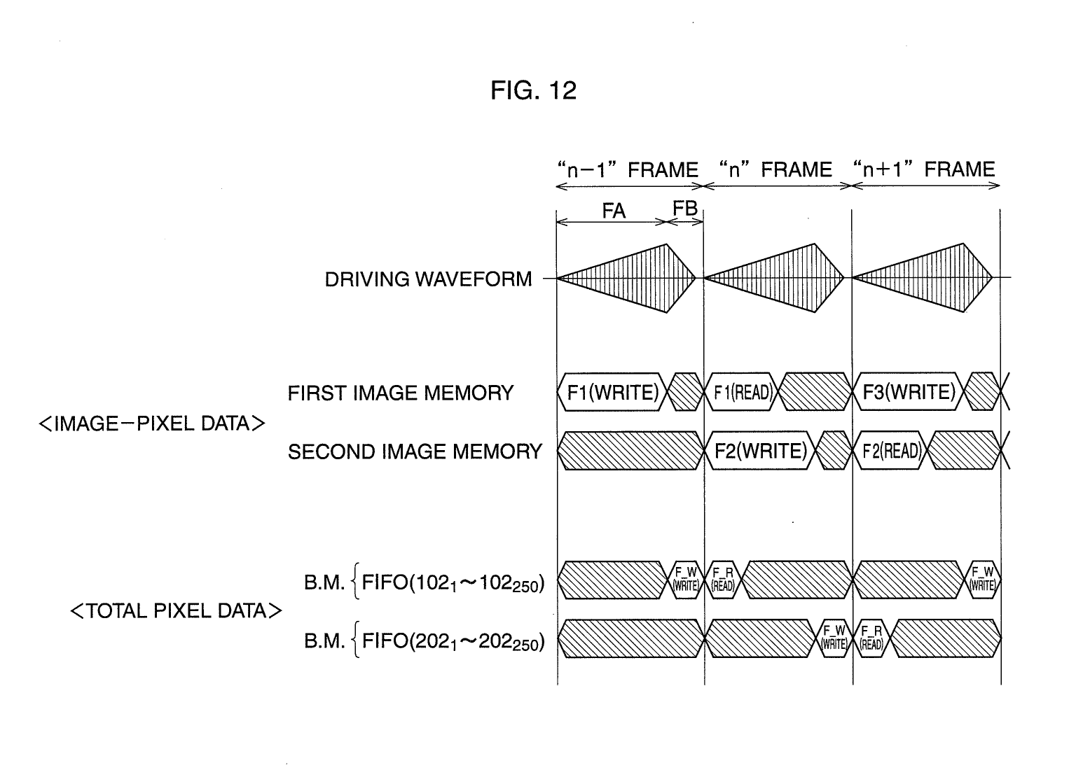

Next, the third embodiment is explained with reference to FIG. 12. The third embodiment is different from the second embodiment in that one frame's worth of pixel signals for calculating an average pixel is detected in a return interval.

FIG. 12 is a timing chart of an image-pixel generating process according to the third embodiment.

As shown in FIG. 12, during the return interval FB in the number “n−1” frame interval, one frame's worth of pixel signals are again detected and stored in the buffer memory 102₁ to 102₂₅₀. Namely, previous pixel information for calculating an average pixel is independently detected in the return interval FB. In the number “n” frame interval, image-pixel signals are generated from pixel signals detected in the present “n” frame interval and the previous pixel signals stored in the buffer memories 102₁ to 102₂₅₀.

In the third embodiment, there is only a short time difference between the writing of pixel signals in the number “n−1” frame interval and the reading of the stored pixel signals. Therefore, image pixels can be calculated on the basis of immediate pixel formation detected in the return interval FB, which is extremely close to the next frame interval.

The number of pixel signals constituting the proximity pixel group may be optionally set. As for the image-pixel calculation methodology, a calculation method other than the above-described method may be optionally applied.

The size of the central area may be defined in accordance to a scanning speed, a density of spiral scan lines, sampling rate, frame interval, etc. Also, an area, in which a rate of the number of image pixels to the number of sampled pixel signals exceeds a given threshold, can be defined as an area for generating image-pixels. For example, an area in which more than 80% of detected pixel signals are abandoned in the case of the down-sampling process may be defined as an area for generating image-pixels. Furthermore, a spiral scan method other than the vibration of the fiber tip portion (for example, the driving of an optical lens) may be carried out.

The present disclosure relates to subject matter contained in Japanese Patent Application No. 2008-326421 (filed on Dec. 22, 2008), which is expressly incorporated herein, by reference, in its entirety.

1. An endoscope system comprising:
an optical fiber configured to transmit illumination light emitted from a light source to the tip portion of a scope;
a scanner configured to spirally scan a target area with the illumination light by vibrating the tip portion of said optical fiber;
a pixel signal detector configured to detect pixel signals on the basis of light reflected from the target area at a given sampling rate; and
an image-pixel generator that generates image-pixels of an observation image on the basis of the detected pixel signals, said image-pixel generator generating each image pixel from a proximity pixel group that comprises a subject pixel signal located at a position of the image pixel and the surrounding pixel signals.

2. The endoscope system of claim 1, wherein said image-pixel generator configures the proximity pixel group on the basis of pixel signals located before and after the subject pixel signal, along a spiral scan line.

3. The endoscope system of claim 1, wherein said image-pixel generator configures the proximity pixel group on the basis of pixel signals that are two-dimensionally arrayed on a plurality of spiral scan lines.

4. The endoscope system of claim 3, wherein said image-pixel generator configures the proximity pixel group on the basis of pixel signals detected in a previous frame interval.

5. The endoscope system of claim 4, wherein said pixel signal processor detects one frame's worth of pixel signals during a return interval when the fiber tip portion returns to a scan starting point.

6. The endoscope system of claim 1, wherein said image-pixel generator generates image pixels by using the proximity pixel group while scanning a predetermined area where a rate of the number of image pixels to the number of sampled pixel signals exceeds a given threshold value.

7. The endoscope system of claim 6, wherein said image-pixel generator applies a down-sampling process to the pixel signals in accordance to a given pixel interval that is defined by each spiral scan line, when scanning an area other than the predetermined area.

8. The endoscope system of claim 1, wherein said image-pixel generator generates image pixels by using the proximity pixel group while scanning a central area.

9. The endoscope system of claim 1, wherein said image generator changes at least one of the number of pixel signals constituting the proximity pixel group and an image-pixel generating method in accordance to a luminance level of one frame's worth of pixel signals.

10. The endoscope system of claim 1, wherein said image-pixel generator carries out at least one of an average value calculating process, a low-pass filtering process, a center pixel sampling process, and a maximum value calculating process.

11. An apparatus for image-pixels of an observation image according to an endoscope system, comprising:
a pixel signal detector configured to detect pixel signals on the basis of light reflected from a target area at a given sampling rate while spirally scanning the target area with illumination light in accordance to a given frame interval; and
an image-pixel generator that generates image-pixels of an observation image on the basis of the detected pixel signals, said image-pixel generator generating each image pixel from a proximity pixel group that comprises a subject pixel signal located at a position of the image pixel and the surrounding pixel signals.

12. A method for image-pixels of an observation image according to an endoscope system, comprising:
detecting pixel signals on the basis of light reflected from a target area at a given sampling rate while spirally scanning the target area with illumination light in accordance to a given frame interval; and
generating image-pixels of an observation image on the basis of the detected pixel signals; the generating including generating each image pixel from a proximity pixel group that comprises a subject pixel signal located at a position of the image pixel and the surrounding pixel signals.
